(19) United States
(12) Patent Application Publication
(10) Pub. No.: US 2026/0079969 A1
(43) Pub. Date: Mar. 19, 2026

(54) NON-DETERMINISTIC LLM AGENT STATE TRANSITION SPECIFICATION, MONITORING, AND CORRECTION

(71) Applicant: International Business Machines Corporation, Armonk, NY (US)

(72) Inventors: Maxwell Crouse, Chicago, IL (US); Pavan Kapanipathi Bangalore, White Plains, NY (US); IBRAHIM ABDELAZIZ, TARRYTOWN, NY (US); Kinjal Basu, Mckinney, TX (US); Soham Dan, Astoria Queens, NY (US); SADHANA KUMARAVEL, White Plains, NY (US); Achille Belly Fokoue-Nkoutche, White Plains, NY (US); Luis A. Lastras-Montano, Cortlandt Manor, NY (US)

(73) Assignee: International Business Machines Corporation, Armonk, NY (US)

(21) Appl. No.: 18/889,561

(22) Filed: Sep. 19, 2024

(51) Int. Cl. G06F 16/332

(52) U.S. Cl. CPC G06F 16/3329; G06F 16/3326

(57) ABSTRACT

An embodiment includes non-deterministic agent state transition behavior specification, monitoring, and correction. An embodiment establishes an agent, wherein the agent is configured to output text in response to input text. The embodiment defines an agent behavior specification for the agent. The embodiment inputs a text input to the agent and monitors the text output of the agent to detect an incorrect state transition, wherein the incorrect state transition comprises a state transition that deviates from the agent behavior specification. The embodiment applies a correction to the output text to create a corrected output text upon detecting the incorrect state transition. The embodiment reverts the agent to a previous state, the previous state preceding the state corresponding to the incorrect state transition detected. The embodiment inputs the corrected output text to the agent in the previous state to cause future behavior of the agent to align with the agent behavior specification.

### BACKGROUND

The present invention relates generally to LLM agent programming. More particularly, the present invention relates to a method, system, and computer program for formally specifying non-deterministic state transition behavior for an LLM agent.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries. Accordingly, AI systems may be designed for various tasks that traditional computer systems were previously incapable, such as for example,

An Artificial Neural Network (ANN)—also referred to simply as a neural network-is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior. Further, ANNs can be designed to uncover relationships between previously unknown features, factors, characteristics, etc.

In the realm of AI and natural language processing (NLP), a large language model (LLM) agent refers to a sophisticated AI system that is trained on vast amounts of text data to understand and generate human-like text responses. LLM agents are built using deep learning techniques, such as, for example, transformer-based architectures, to process and generate text in a contextually coherent and meaningful manner. These agents have the capability to comprehend complex language structures, infer context from input data, and produce responses that mimic human language patterns. The training process of an LLM agent involves exposing the model to massive datasets of text from various sources, such as books, articles, websites, and other textual content. By learning from this diverse corpus of text data, the LLM agent develops a rich understanding of language semantics, syntax, and context. These agents can perform a wide range of natural language processing tasks, including text generation, sentiment analysis, language understanding, and dialogue systems.

### SUMMARY

The illustrative embodiments provide for high level LLM agent behavior specification and state transition monitoring and correction. An embodiment includes establishing an agent, such that the agent is configured to output text in response to input text. An embodiment also includes defining an agent behavior specification for the agent. An embodiment also includes inputting a text input to the agent and monitoring the text output of the agent to detect an incorrect state transition, wherein the incorrect state transition comprises a state transition that deviates from the agent behavior specification. An embodiment also includes applying a correction to the output text to create a corrected output text upon detecting the incorrect state transition. An embodiment also includes reverting the agent to a previous state, the previous state preceding the state corresponding to the incorrect state transition detected. An embodiment also includes inputting the corrected output text to the agent in the previous state to cause future behavior of the agent to align with the agent behavior specification.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example computing environment for defining agent behavior in accordance with an illustrative embodiment;

FIG. 3 depicts a block diagram of an example sequence of agent states in accordance with an illustrative embodiment;

FIG. 4 depicts a visual display of an example sequence of agent states in accordance with an illustrative embodiment;

FIG. 5 depicts a block diagram of an example system for monitoring and correcting agent behavior in accordance with an illustrative embodiment;

FIG. 6 depicts a block diagram of an example agent behavior module in accordance with an illustrative embodiment; and

FIG. 7 depicts a flowchart of an example process monitoring and correcting agent behavior accordance with an illustrative embodiment.

### DETAILED DESCRIPTION

In the context of Artificial Intelligence and Machine Learning, agents are entities that can perceive their environment, make decisions, and take actions to achieve specific goals. These agents operate based on predefined rules, algorithms, and/or models that govern their behavior and decision-making processes. In the case of LLM-based agents designed for natural language tasks, these agents leverage large language models to process and generate human-like text responses to input data, such as text prompts or queries.

A state machine is a computer model that defines a set of states, transitions between these states, and the conditions or events that trigger these transitions. In the context of LLM-based agents, the state machine represents the different states the agent can be in during task execution, such as thought, action, observation, etc. Each state is associated with specific behaviors, actions, or decision-making processes that the agent follows based on the input data and internal processing.

Further, as an LLM-based agent interacts with natural language input data, the agent may progress through different states in a state machine based on the rules and constraints defined in a high-level model. The agent's behavior in each state influences the agent's decision-making process and the generation of output responses. By transitioning between states and following the specified behavior outlined in the model, the agent can effectively process the input data, make informed decisions, and produce coherent natural language responses that reflect its understanding of the task at hand.

The use of large language models has become prevalent in the design of modern agents. However, large language models require immense computational resources in comparison to previous computer technologies. For example, in some instances, an LLM query may require over a thousand times the amount of computer resources than a traditional search engine to produce the same result(s). Accordingly, an LLM query may be more computationally expensive than a traditional search engine query due to the underlying mechanisms and processes involved in generating responses. For example, the computational expense of an LLM query may be the result of a combination of the complexity of the neural network architecture, the process of generating human-like text responses, as well as the need for fine-tuning the model for specific tasks.

Currently existing methods of prompt engineering require an extraordinary amount of computer resources to accomplish. Since a query entered into a large-language model on average requires much greater amounts of computational resources to accomplish than traditional technologies, the fewer queries required to provide accurate sufficient results massively improves the computational efficiency of LLM based querying.

Accordingly, the present disclosure addresses the deficiencies described above by providing a process (as well as a system, method, machine-readable medium, etc.) that develops a system for formally specifying the high-level behavior of LLM-based agents. In an embodiment, the process includes defining non-deterministic state transition behavior for an LLM agent. In some embodiments, the process includes establishing a decoding monitor for decoding output responses of an LLM agent. In some embodiments, the process includes establishing a correction mechanism for correcting output of an LLM agent. An embodiment leverages a decoding monitor to enable agent behavior correction without the creation of decision bias for the agent. In some embodiments, the process leverages one or more machine learning techniques, such as for example to uncover relationships between features that may affect state transitions and/or high level agent behavior.

The illustrative embodiments provide a system for formally specifying the high-level behavior of LLM-based agents. Further, illustrative embodiments provide a process of monitoring and correcting agent behavior upon detection from deviation from specified behavior. Further, the illustrative embodiments provide establishing a decoding monitor configurable to detect transitions between states of an LLM-based behavior. Further, the illustrative embodiments provide establishing a correction module configurable to apply a correction to the output. Further, illustrative embodiments provide inputting the corrected output to a text generator, and continuously monitoring state transition behavior to maintain alignment with specification behavior criteria.

In an embodiment, the following time steps describe an example process of text generation, monitoring, correction, and termination within the system. A long string of text is generated by a text generator, such as an LLM agent, based on the input data and the model's learned parameters. The generated text string is passed to the decoding monitor, which evaluates the text against the specified behavior defined in the high-level model. The decoding monitor splits the text along each state defined in the model, segmenting the text into distinct sections corresponding to different states (e.g., “Thought,” “Action,” “Observation”). The decoding monitor walks through the sequence of states in the text, monitoring the transitions between states until the decoding monitor detects an incorrect state based on the expected behavior. Upon detecting an incorrect state (e.g., an “Action” state followed by a “Thought” state), the decoding monitor discards all text following the incorrect state to prevent the propagation of errors. The truncated text is then fed to a correction module, which applies corrections to rectify the deviation from the expected behavior and ensure the integrity of the text. The correction module modifies the text to fix any errors or inconsistencies, ensuring that the text aligns with the specified behavior and state transitions. The corrected text is then passed back to the text generator, which receives the fixed text and continues the generation process from the beginning, incorporating the corrections made by the correction module. The generation process continues until the final state is reached, at which point the decoding monitor terminates the generation process, signaling the completion of text generation based on the specified behavior and state transitions outlined in the model. In an embodiment, the system may include one or more deep learning mechanisms trained on labeled data to identify states and transitions between states (i.e., agent behavior).

As used throughout the present disclosure, the term “large language model agent” (or simply “LLM” agent) refers to a type of artificial intelligence model capable of generating human-like text based on received input. For the purposes of this disclosure, the terms “agent”, “LLM agent”, “text generator”, and like terms may all be used interchangeably, unless otherwise indicated by the context. Illustrative embodiments provide for formally specifying the high-level behavior of an LLM agent.

As used throughout the present disclosure, the term “high-level behavior” (or simply “behavior”) refers to a collection of actions, responses, and outputs exhibited by an agent in various states and transitions. The behavior of an LLM agent may be determined by internal mechanisms, algorithms, and/or training data, which influence how the agent processes input, generates output, and/or interacts with users and/or systems. For the purposes of this disclosure, the term “behavior” also refers to the transitions between states, indicating how the agent moves from one state to another based on input and/or internal processes. Formal specification of behavior may include defining the expected responses, patterns, and/or outcomes of the LLM agent under different conditions, inputs, and scenarios to ensure consistent and reliable performance. Some embodiments of the present disclosure include defining non-deterministic state transition behavior.

An embodiment of the present disclosure includes providing a decoding monitor configured to decode an agent's state at a present moment in time, as well as transitions between states. An embodiment of the present disclosure may also utilize a decoding monitor to discover a previously undefined state. For example, suppose based on an input, the output is expected to be one of states A, B, or C. Continuing on this example scenario, suppose the output does not belong to any of these previously defined states. In such instances, the decoding monitor may classify a new state, (e.g., state “D”) to capture the undefined state. Further, in future monitoring, the decoding monitor may be configured to detect states A, B, C, and state D. It is contemplated herein that discovery of “new” or previously undefined states may aid in analysis of state transition behavior of the agent. Accordingly, by capturing an undefined state, the decoding monitor enables the system to adapt and recognize new patterns or emergent behaviors exhibited by an LLM agent. This capability provides insights into how the agent's responses evolve over time and in different contexts, facilitating a deeper understanding of its decision-making processes and improving the overall performance and reliability of the system.

As used throughout the present disclosure, the term “state” refers to a specific configuration or condition of an agent at a particular point in time during operation. The state may include all the relevant information about the agent's internal variables, memory, and/or context that determine and/or influence agent behavior and/or output at that moment. States can change based on input, internal processing, or external factors, leading to different behaviors and outcomes. Examples of formal agent states may include, but are not limited to the following example states: “Thought”, “Observation”, “Action”, etc.

As used throughout the present disclosure, the term “state transition” (or simply “transition”) refers to the traversal of an LLM agent from one state to another state in response to input, stimuli, and/or internal processes. Accordingly, a transition represents a changes in the internal state and/or configuration of an agent as the agent processes information and/or interacts with the environment. In an embodiment, a state transition may be governed at least in part by one or more predefined rules, algorithms, and/or models that dictate how the agent should behave in different situations.

Illustrative embodiments include receiving, via the decoding monitor, a text string from a text generator. Illustrative embodiments include inspecting the text string until detecting an incorrect state transition. Illustrative embodiments include, upon detection of the incorrect state transition, transmitting a portion of the text string into a correction module, wherein the correction module outputs a corrected output text string. Illustrative embodiments include inputting the corrected output text string to the text generator. Illustrative embodiments include iteratively performing steps of the above process until a final state is reached, upon which the decoding monitor outputs a terminal signal to terminate the process and text generation.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

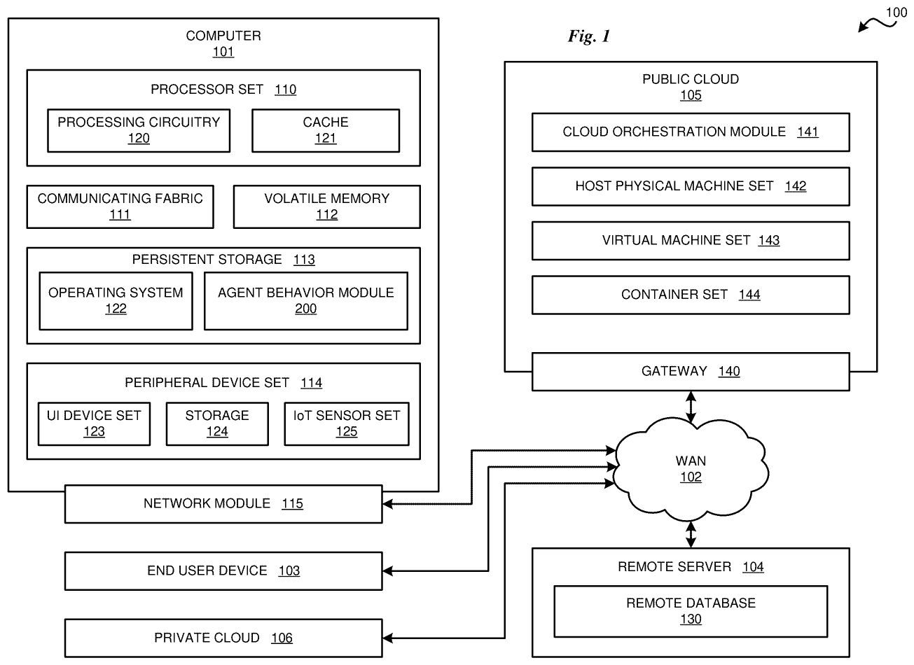

With reference to FIG. 1, this figure depicts a block diagram of a computing environment 100. Computing environment 100 contains an example of an environment for the execution of at least some of the computer code involved in performing the inventive methods, such as agent behavior module 200 that may be configured to specify high-level agent behavior and monitor and correct agent behavior upon detection of deviation from specified behavior. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

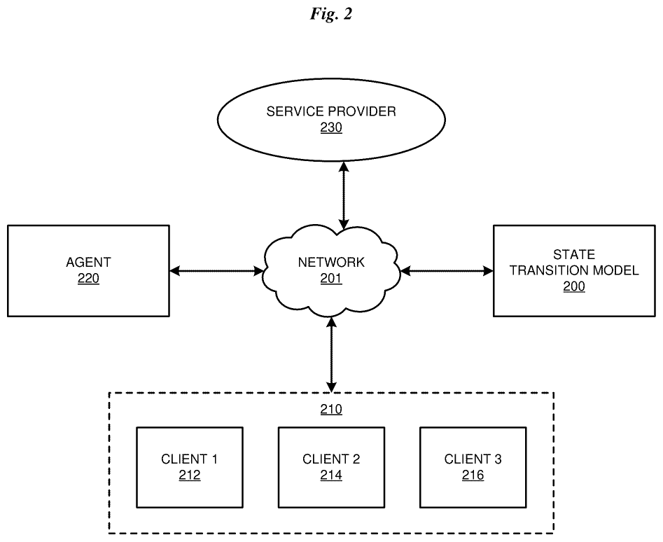

With reference to FIG. 2, this figure depicts a block diagram of an example system for specifying high-level agent behavior. In the illustrated embodiment, the system includes service provider 230 offering an LLM agent 220, an agent behavior module 200 responsible for monitoring and correcting agent behavior of agent 220, and a set of clients 210 that interact with the agent 220, all connected via network 201. In the illustrated embodiment, network 201 may include aspects of any suitable network configuration, and may include, for example, the Internet.

In the illustrated embodiment, agent behavior module 200 is a software module configured to establish a specification for agent 220, as well as monitor the output of agent 220 until detection of deviation from the specification. In an embodiment, upon detection of an improper state transition, the agent behavior module 200 employs a correction mechanism to correct the output of agent 220. In an embodiment, the agent behavior module 200 includes a state machine configured to define states, transitions, and/or behaviors that agent 220 should exhibit during text generation.

In an embodiment, the agent behavior module 200 defines the states within the state machine to represent different configurations or conditions of the LLM agent 220 during text generation. Each state encapsulates specific characteristics, rules, and context that dictate the behavior and output of the agent. In an embodiment, the agent behavior module 200 monitors the behavior of the LLM agent 220 by observing the transitions between states as dictated by the state machine. In an embodiment, the agent behavior module 200 tracks the sequence of states and ensures that the agent follows the specified behavior patterns and transitions outlined in the state machine. In an embodiment, when deviations or errors are detected in the behavior of the LLM agent 220, the agent behavior module 200 utilizes the state machine to identify the correct states and transitions. By referencing the state machine, the module can determine the expected behavior and make corrections to realign the agent's behavior with the specified model.

In an embodiment, the agent behavior module 200 analyzes output text data of LLM agent 220 to determine a sequence of states. In an embodiment, the agent behavior module 200 segments the generated text data into separate states, thereby creating a sequence of states from the output generated text. In an embodiment, detecting an improper state transition includes analyzing output text generated to determine the state of LLM agent 220 based on the text data generated. In an embodiment, detecting an improper state transition includes comparing the most recent state LLM agent 220 to the state immediately preceding the most recent state, to determine the state transition between those states. In an embodiment, if the state transition between those states is incorrect with regards to the specification, then the LLM agent 220 determines that an improper state transition has occurred.

In an embodiment, the specification may define correct and/or incorrect state transitions. In some embodiment, the specification may include a set of correct state transitions, such that any state transition not defined as a correct state transition in the specification may be identified as an incorrect state transition. In some embodiments, the specification may include a set of improper state transitions, such that any transition may be considered a correct transition, except those state transitions defined in the set of improper state transitions. In some embodiments, the specification may include a combination of defined correct and/or incorrect state transitions.

In an embodiment, the agent behavior module 200 may include a mapping defining text features with corresponding states. Accordingly, an embodiment may include establishing a mapping between text features and corresponding states. In an embodiment, one or more machine learning algorithms is trained and/or configured to identify the state of an LLM agent 220 based on output text generated by the LLM agent 220. In an embodiment, determining a state of an LLM agent 220 is accomplished by comparing the output text generated by the LLM agent 220 against the mapping to identify one or more states of the LLM agent 220 at one or more instances in time.

In the illustrated embodiment, the set of clients 210 includes a first client 212, a second client 214, and a third client 216. In some embodiments, each client of set of clients 210 may interact the same version of agent 220 whose behavior has been specified in the same manner by agent behavior module 200. In some other embodiments, each client of the set of clients 210 may individually interact with an individualized instance of agent behavior module 200 and/or agent 220 to specify, monitor, and/or correct agent behavior.

In some embodiments, the agent behavior module 200 comprises a physical computing device, including but not limited to, a personal computer, a laptop, a smartphone, a tablet, etc. In some embodiments, the agent behavior module 200 comprises specialized hardware, such as for example, a Application-Specific Integrated Circuit (ASIC) or Field-Programmable Gate Array (FPGA) for accelerated processing of specific tasks, routines, algorithms, training operations, etc. In some embodiments, the agent behavior module 200 may include a combination of physical and virtualized components, as well as may be partially or entirely virtualized on a virtual machine.

As described herein, the agent behavior module 200 may provide a specification, monitor, and correction system that manifests in the form of an Internet website or a mobile application that is accessible by a user device of service provider 230. A backend administration system allows users with administrative privileges to perform various administrative tasks associated with agent behavior module 200, such as defining agent specification, initiating a data collection and/or correlation process, a neural network training process, defining optimization goals, defining execution parameters/criteria, defining subjective metrics, and any other defined settings discussed herein.

In some embodiments, agent behavior module 200 connects with API gateway via any suitable network 201 or combination of networks such as the Internet, etc. and uses any suitable communication protocols such as Wi-Fi, Bluetooth, etc. to connect to service LLM agent 220 and/or service provider 230. The API gateway may transmit service requests received from the set of clients 210 to agent behavior module 200.

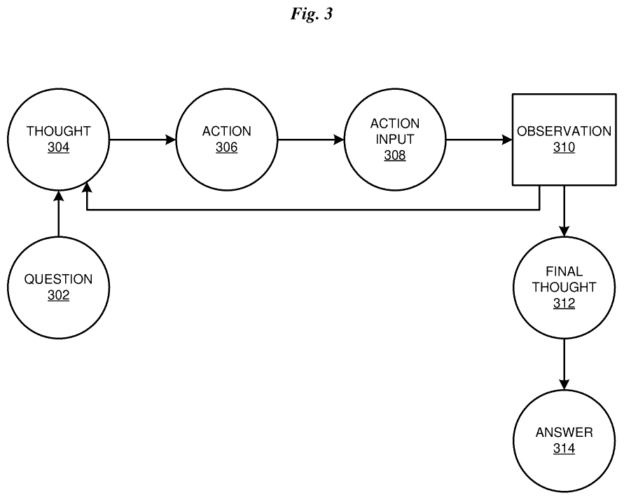

With reference to FIG. 3, this figure depicts an example sequence of state transitions, in accordance with an illustrative embodiment. In the text generation process, an LLM agent transitions between different states, such as, for example, “thought”, “action”, “observation”, etc. Accordingly, each state represents a specific configuration or condition of the agent that influences the agent behavior and/or output. For example, in the “thought” state, the LLM agent may process and analyze the input data, formulate ideas, and/or generate internal representations of the information. Further, the “action” state may include the LLM agent translating its thoughts and/or internal representations into actionable steps. In this state, the agent may generate text outputs based on the processed information and decisions made during the thought state. Further, in the “observation” state, the LLM agent may evaluate and/or review the generated text output. In an embodiment, the agent observes its own output to identify areas for improvement or correction.

The sequence of states and transitions between each state define the behavior of the LLM agent during text generation. With continued reference to FIG. 3, an example sequence of states is depicted. In the illustrative embodiment, an agent receives a question 302 and in response enters into a thought state 304, followed by an action state 306, followed by an action input state 308, followed by an observation state 310, which may be iteratively repeated until a final thought state 312 is reached. Upon entering a final thought state 312, an answer 314 is output. In an embodiment, the agent may transition from the thought state 304 to the action state 306 when the agent has processed the input data and is ready to generate text. Subsequently, the agent may transition to the observation state 310 to review and evaluate the generated text before transitioning back to the thought state 304 to continue processing new input data.

In an embodiment, the transitions between states may be guided by predefined rules, logic, and/or models that dictate how the agent moves from one state to another based on the input data, internal processing, and/or contextual cues. The sequence of states and transitions forms a structured framework that governs the behavior of the LLM agent. By defining the states and transitions, and monitoring and correcting the behavior of the agent, the example embodiments of processes described herein optimize the behavior of the agent to produce high-quality, accurate, and contextually relevant text outputs that consume substantially less computer resources than other existing practices require.

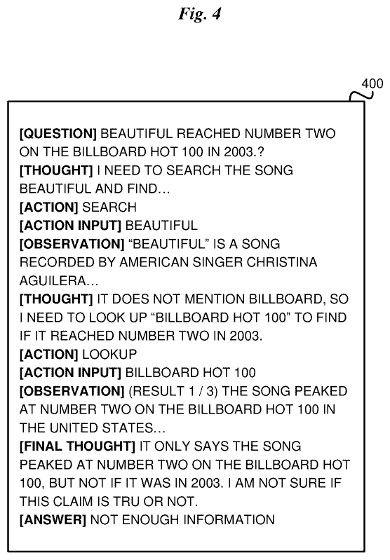

With reference to FIG. 4, this figure depicts an example display of a sequence of state transitions, in accordance with an illustrative embodiment. In the illustrative embodiment, the sequence 400 may include the example sequence depicted by FIG. 3. Accordingly, in response to a question, a “thought” is followed by an “action” which is followed by an “action input” which is followed by an “observation” which is followed by a “final thought” which is concluded with an output answer. By monitoring the transition between each state to every other state, the example processes herein are configured to detect an improper state transition. Accordingly, an improper state transition may be indicative of deviance from specified behavior.

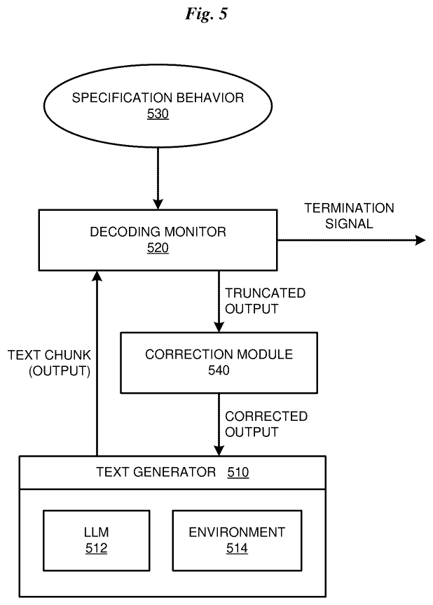

With reference to FIG. 5, this figure depicts a block diagram of an example system for monitoring and correcting agent behavior, in accordance with an illustrative embodiment. In an embodiment, the system includes a high-level specification of model behavior. In an embodiment, specification behavior 530 defines the behavior of an LLM-based agent in terms of states such as thought, action, observation, etc. Each state may be defined along with the behavior that dictates when the model transitions from one state to another. In an embodiment, specification behavior 530 serves as a guide for the LLM-based agent's decision-making process during natural language tasks. In an embodiment, the system includes a state machine representation of agent behavior. The state machine captures the various states the agent can be in and the transitions between these states based on the input and internal processing.

In the illustrative embodiment, the system includes a decoding monitor 520. In an embodiment, the decoding monitor is configured to detect deviations in the behavior of the LLM-based agent from the expected behavior specified in the high-level specification. When the decoding monitor 520 identifies such deviations during the generation of a natural language response, the decoding monitor 520 triggers intervention to correct the behavior of the agent and bring it back in line with the specified behavior. In an embodiment, the decoding monitor 520 continuously evaluates the output generated by the agent during natural language tasks and compares it against the expected behavior defined in the model. By monitoring the agent's behavior in real-time, the decoding monitor can promptly detect any deviations or inconsistencies that may arise during the task execution process. This real-time monitoring capability enables the system to intervene immediately when deviations are identified, preventing the agent from straying off course and ensuring the accuracy and reliability of the generated responses. In an embodiment, the decoding monitor 520 transforms output text generated by an LLM agent into a sequence of states that collectively from a sequence of state transitions. In an embodiment, transforming output text generated by the LLM agent into a sequence of state transitions includes segmenting text output into distinct states responsible for generating a particular segment.

In an embodiment, the system continuously assesses the output of the LLM-based agent and provides corrective feedback when deviations from the expected behavior are detected. In some embodiments, intervention is triggered only when deviations in the agent's behavior are identified, ensuring that corrective actions are taken selectively and efficiently. By intervening only when necessary, the decoding monitor minimizes disruptions to the task execution process and optimizes the system's performance in generating natural language responses. Further, selective intervention reduces the possibility of introducing any bias into the system. Further, selective intervention reduces computational cost of reconfiguring model settings unnecessarily. This targeted intervention approach provides the LLM-based agent the flexibility to adapt to varying inputs and tasks within the constraints of the high-level model in a computationally cost effective manner.

In an embodiment, the system creates constraints for transitions between states by utilizing the state machine representation of the agent's behavior. The state machine defines the various states that the LLM-based agent can be in and specifies the conditions under which transitions between these states occur. Each state in the state machine may be associated with a set of rules or criteria that must be satisfied for the agent to transition from one state to another. These rules serve as constraints that govern the agent's behavior and dictate the flow of the task execution process.

The constraints for transitions between states are established based on the behavior specified in the high-level model. The high-level model outlines the expected behavior of the agent, including the sequence of states the agent should traverse and the conditions under which transitions should occur. By aligning the constraints for state transitions with the behavior defined in the high-level model, the system ensures that the agent follows a predefined path and adheres to the intended decision-making process during task execution.

Moreover, the system enforces constraints for transitions between states by monitoring the agent's actions and interactions with the input data. As the agent processes the natural language input and progresses through different states in the state machine, the system continuously evaluates the agent's behavior against the specified constraints. If the agent's actions deviate from the expected behavior or fail to meet the transition criteria between states, the system can intervene through the decoding monitor and correction module to guide the agent back on track and enforce the constraints for state transitions. This proactive monitoring and intervention mechanism help maintain the integrity of the agent's behavior and ensure that it operates within the defined constraints throughout the task execution process. In an embodiment, the system includes a correction module 540. The correction module works in conjunction with the decoding monitor to assist the LLM-based agent in correcting its behavior when deviations are detected. By providing guidance and feedback to the agent based on the specified behavior, the correction module helps the agent adhere to the intended state transitions and overall behavior defined in the high-level specification.

In the illustrated embodiment, a long string of text is generated by a text generator 510, such as an LLM agent 512 or the environment 514, based on the input data and the model's learned parameters. The generated text string is passed to the decoding monitor 520, which evaluates the text against the specified behavior defined in the high-level model. The decoding monitor 520 splits the text along each state defined in the model, segmenting the text into distinct sections corresponding to different states (e.g., “Thought,” “Action,” “Observation”).

The decoding monitor 520 walks through the sequence of states in the text, monitoring the transitions between states until the decoding monitor detects an incorrect state based on the expected behavior. Upon detecting an incorrect state (e.g., an “Action” state followed by a “Thought” state), the decoding monitor discards all text following the incorrect state to prevent the propagation of errors. The truncated text is then fed to a correction module 540, which applies corrections to rectify the deviation from the expected behavior and ensure the integrity of the text. The correction module modifies the text to fix any errors or inconsistencies, ensuring that the text aligns with the specified behavior and state transitions.

The corrected text is then passed back to the text generator 510, which receives the fixed text and continues the generation process from the beginning, incorporating the corrections made by the correction module 540. The generation process continues until the final state is reached, at which point the decoding monitor terminates the generation process, signaling the completion of text generation based on the specified behavior and state transitions outlined in the model.

In an embodiment, the system includes a code-free (high-level language) implementation of LLM-based agents. This implementation allows users to define and execute LLM-based agents without the need for low-level programming or coding. The use of a high-level language simplifies the process of creating and deploying LLM-based agents for natural language tasks, making it accessible to a wider range of users with varying technical backgrounds.

In an embodiment, the system enables flexibility in defining novel agents through its framework. The framework provides the tools and structure necessary to define unique LLM-based agents with custom behaviors and state transitions. This flexibility allows users to tailor the behavior of the agents to specific tasks or domains, expanding the capabilities of the system beyond predefined models.

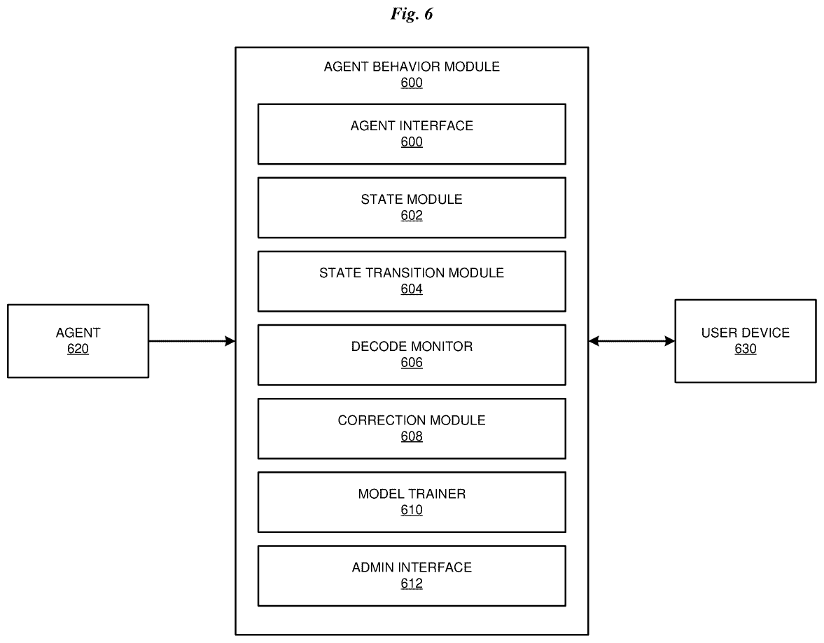

With reference to FIG. 6, this figure depicts a block diagram of an example software module for specifying high-level agent behavior. In the illustrative embodiment, the Agent Behavior Module 600 is a software module configured to monitor and correct the behavior of the LLM agent throughout the text generation process. In the illustrated embodiment, the Agent Behavior Module 600 includes the following example modules: Agent Interface Module 602, State Module 604, State Transition Module 606, Decode Monitor 608, Correction Module 610, Model Trainer 612, and Admin Interface 614.

In the illustrative embodiment, Agent Interface Module 602 includes a software module configured to facilitate communication between the Agent Behavior Module 600 and the LLM agent 620. In an embodiment, Agent Interface Module 602 enables the Agent Behavior Module 600 to receive text data from the LLM agent 620 and provides instructions and feedback to guide the agent's behavior during text generation.

In the illustrative embodiment, State Module 604 includes a software module configured to define and manage the different states within the high-level model. In an embodiment, the State Module 604 may be configured to establish the criteria and/or characteristics of each state (e.g., “Thought,” “Action,” “Observation”) based on the specified behavior outlined in the model. In an embodiment, the State Module 604 may categorize the text generated by an LLM agent into distinct sections corresponding to the defined states, thereby enabling monitoring and analysis of the agent's behavior.

In an embodiment, the State Transition Module 606 includes a software module configured to monitor and track the transitions between states in the text generated by the LLM agent. The State Transition Module 606 identifies the sequence of states in the text and observes the flow of transitions between different states. In an embodiment, the State Transition Module 604 provides real-time monitoring and analysis of the agent's behavior.

In an embodiment, the Decode Monitor 608 is a software module configured to evaluate the text generated by the LLM agent against the specified high-level behavior of the model. In an embodiment, to monitor the behavior of an LLM agent based on generated text, the Decode Monitor 608 splits the text into sections corresponding to different states defined in the model and walks through the sequence of states to detect any deviations or incorrect states. In an embodiment, the Decode Monitor 608 is configured to identify errors or inconsistencies in the text and signal the need for corrective action from another module/system. In an embodiment, the Decode Monitor 608 is configured to detect and classify a previously undefined state, based on user criteria.

In an embodiment, the Correction Module 608 is a software module configured to apply corrections to the text when deviations from the expected behavior are detected by the Decode Monitor 608. In an embodiment, the Correction Module 610 rectifies errors and/or inconsistencies in the text to ensure that it aligns with the specified behavior and state transitions outlined in the model. In an embodiment, the Correction Module 610 is configured prevent an agent from producing invalid state as opposed to biasing an agent to produce one of a correct state.

In an embodiment, the Correction Module 610 is a software module configured to apply corrections to the text when deviations from the expected behavior are detected by the Decode Monitor 608. As part of the correction process, the Correction Module 608 retrieves the set of valid states from the state machine based on the last observed state. Accordingly, the Correction Module 610 may analyze the prompt texts associated with each valid state and determine the longest common prefix among these prompt texts for each state. In an embodiment, Correction Module 610, the module employs valid state prefixing to rectify errors in the text generated by the LLM agent.

In an embodiment, the Correction Module 610 receives the last observed state and retrieves from the state machine the set of next valid states based on this state. Correction Module 610 analyzes the prompt texts associated with each valid state and determines the longest common prefix among these prompt texts for each state. For example, when comparing the states “[Action]” and “[Action Input]”, if the resulting text is “[Action”, the Correction Module 608 identifies the longest common prefix as “[Action”. As another example, when comparing the states “[Action]” and “[Thought]”, if the resulting text is “[”, the common prefix is determined to be “[”.

In an embodiment, upon determination of the longest common prefix is determined, the Correction Module 610 truncates the original text to include only the common prefix and then appends this prefix to the truncated original text. This combined text, comprising of the truncated original text followed by the common prefix, is then returned as the corrected output. The corrected output, comprising of the truncated original text followed by the common prefix, may then returned as the final corrected text. This process ensures that the text aligns with the expected behavior and maintains coherence and consistency in the text generation process, enhancing the overall quality and accuracy of the generated text.

Further, by truncating the original text to include only the common prefix and then appending the prefix, the Correction Module 610 ensures that the corrected text aligns with the shared context identified between the observed states. This approach helps maintain coherence and consistency in the text generation process by preserving the relevant content while incorporating the common elements that bridge the different states. Further, by identifying the longest common prefix of the prompt texts for each valid state, the Correction Module 608 gains insights into the shared context or themes that are relevant to transitioning to the next state. This analysis helps the Correction Module 610 make informed decisions about the corrections needed to align the text with the desired and/or expected behavior and state transitions.

In the illustrative embodiment, Model Trainer 614 includes a software module configured to train one or more machine learning mechanisms described herein. In an embodiment, Model Trainer 612 is configured train and update the high-level model based on the feedback and corrections provided during the text generation process. In an embodiment, the Model Trainer 612 incorporates the insights and adjustments made by the Correction Module 610 to enhance the model's performance and accuracy over time. In an embodiment, the Model Trainer 612 utilizes one or more machine learning algorithms and/or techniques to analyze and/or interpret the patterns, structures, and/or characteristics of the text data processed by the Decode Monitor 608.

In an embodiment, the process may leverage aspects of supervised and/or unsupervised learning to recognize states and state transitions and/or discover unexpected states. Through a process of supervised learning, the Model Trainer 612 leverages labeled training data to teach the Decode Monitor how to recognize and classify different states and transitions based on predefined criteria and/or rules. By providing annotated examples of text segments corresponding to different states (e.g., “Thought,” “Action,” “Observation”) and transitions between these states, the Model Trainer 612 enables the Decode Monitor 608 to learn the distinguishing features and patterns associated with each state. In an embodiment, the Model Trainer 612 iteratively refines the Decode Monitor's ability to identify states and transitions by adjusting the model parameters, optimizing the learning algorithms, and validating the performance against a validation dataset.

In the illustrative embodiment, Admin Interface 614 includes a software module configured to allow users with administrative privileges to perform various administrative tasks associated with agent behavior module 200, such as defining agent specification, initiating a data collection and/or correlation process, a neural network training process, defining optimization goals, defining execution parameters/criteria, defining subjective metrics, and any other defined settings discussed herein.

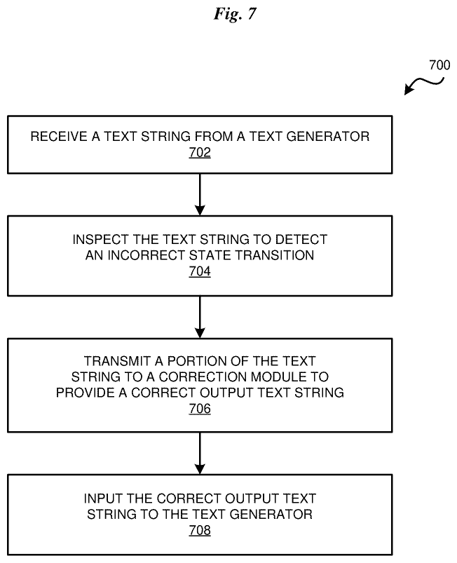

With reference to FIG. 7, this figure depicts a flowchart of an example process of adaptive monitoring and correcting agent behavior. In an embodiment, the agent behavior module 200 of FIG. 1 and FIG. 2, and/or the agent behavior module 600 of FIG. 6 carries out the process 700.

At step 702, the process receives, via a decoding monitor, a text string from a text generator. In an embodiment, a long string of text is generated by a text generator, such as an LLM agent, based on the input data and the model's learned parameters. The generated text string is passed to the decoding monitor, which evaluates the text against the specified behavior defined in the high-level model.

At step 704, the process inspects, via the decoding monitor, the text string for an incorrect state transition. In an embodiment, the decoding monitor splits the text along each state defined in the model, segmenting the text into distinct sections corresponding to different states (e.g., “Thought,” “Action,” “Observation”). The decoding monitor walks through the sequence of states in the text, monitoring the transitions between states until the decoding monitor detects an incorrect state based on the expected behavior.

At step 706, upon detection of the incorrect state transition, the process transmits a portion of the text string to a correction module. In an embodiment, upon detecting an incorrect state (e.g., an “Action” state followed by a “Thought” state), the decoding monitor discards all text following the incorrect state to prevent the propagation of errors. The truncated text may be fed to a correction module, which applies corrections to rectify the deviation from the expected behavior. In an embodiment, the correction module outputs a corrected output string.

At step 708, the process inputs the corrected output text string to the text generator. In an embodiment, the corrected text is passed back to the text generator, which receives the corrected output text and continues the generation process from the beginning, incorporating the corrections made by the correction module. The generation process continues until the final state is reached, at which point the decoding monitor terminates the generation process, signaling the completion of text generation based on the specified behavior and state transitions outlined in the model.

In an embodiment, output text that is passed back to the text generator causes a change in the final output of the text generator, which is caused by inputting a corrected output into the text generator. In an embodiment, the process of passing corrected text output text back into the text generator causes one or more weights corresponding to one or more nodes of a neural network underlying the text generator to adjust in response to receiving the corrected output text. Accordingly, by modifying one or more weights one or more nodes of a neural network, embodiments disclosed herein allow tuning of a text generator as described herein through the decoding, monitoring, and correcting processes as described herein.

Embodiments of the present disclosure leverage utilization of a decode monitor to monitor and correct the state transition behavior of agent until a final state is reached, upon which the monitoring and correcting are terminated. Some such embodiments enable agent behavior correction without the creation of decision bias for the agent. Accordingly, the monitoring and/or correction mechanisms described herein may be configured prevent an agent from producing invalid state as opposed to biasing an agent to produce one of a correct state. Further, since the processes described herein do not introduce decision bias into the system, the system is highly adaptable for non-deterministic systems as well as deterministic systems. In an embodiment, the process includes establishing, training, and/or fine tuning one or more deep learning models to uncover relationships between states and transitions between states. In an embodiment, the system may include one or more deep learning mechanisms trained on labeled data to identify states and transitions between states (i.e., agent behavior).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing an agent, wherein the agent is configured to output text in response to input text;
defining an agent behavior specification for the agent;
inputting a text input to the agent and monitoring the text output of the agent to detect an incorrect state transition, wherein the incorrect state transition comprises a state transition that deviates from the agent behavior specification;
applying a correction to the output text to create a corrected output text upon detecting the incorrect state transition;
reverting the agent to a previous state, the previous state preceding the state corresponding to the incorrect state transition detected; and
inputting the corrected output text to the agent in the previous state to cause future behavior of the agent to align with the agent behavior specification.

2. The computer-implemented method of claim 1, wherein applying a correction to the output text string comprises identifying a longest common string and appending the longest common string to the output text of the previous state.

3. The computer-implemented method of claim 1, further comprising training a deep learning algorithm on labeled data to identify an agent state transition, wherein labels of the labeled data define agent states based on associated characteristics.

4. The computer-implemented method of claim 1, further comprising uncovering a previously unidentified state, wherein the uncovering a previously undefined state comprises identifying a collection of characteristics that do not correspond to previously defined state.

5. The computer-implemented method of claim 1, wherein monitoring the text output of the agent to detect an incorrect state transition comprises:
identifying a collection of characteristics within the output text that correspond to a particular state; and
determining that the particular state is out of sequence with respect to the agent behavior specification.

6. The computer-implemented method of claim 1, wherein the agent behavior specification comprises at least one of a correct sequence of state transitions and an incorrect sequence of state transitions.

7. A computer program product comprising one or more computer readable storage media, and program instructions collectively stored on the one or more computer readable storage media, the program instructions executable by a processor to cause the processor to perform operations comprising:
establishing an agent, wherein the agent is configured to output text in response to input text;
defining an agent behavior specification for the agent;
inputting a text input to the agent and monitoring the text output of the agent to detect an incorrect state transition, wherein the incorrect state transition comprises a state transition that deviates from the agent behavior specification;
applying a correction to the output text to create a corrected output text upon detecting the incorrect state transition;
reverting the agent to a previous state, the previous state preceding the state corresponding to the incorrect state transition detected; and
inputting the corrected output text to the agent in the previous state to cause future behavior of the agent to align with the agent behavior specification.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein applying a correction to the output text string comprises identifying a longest common string and appending the longest common string to the output text of the previous state.

11. The computer program product of claim 7, further comprising training a deep learning algorithm on labeled data to identify an agent state transition, wherein labels of the labeled data define agent states based on associated characteristics.

12. The computer program product of claim 7, further comprising uncovering a previously unidentified state, wherein the uncovering a previously undefined state comprises identifying a collection of characteristics that do not correspond to previously defined state.

13. The computer program product of claim 7, wherein monitoring the text output of the agent to detect an incorrect state transition comprises:
identifying a collection of characteristics within the output text that correspond to a particular state; and
determining that the particular state is out of sequence with respect to the agent behavior specification.

14. The computer program product of claim 7, wherein the agent behavior specification comprises at least one of a correct sequence of state transitions and an incorrect sequence of state transitions.

15. A computer system comprising a processor and one or more computer readable storage media, and program instructions collectively stored on the one or more computer readable storage media, the program instructions executable by the processor to cause the processor to perform operations comprising:
establishing an agent, wherein the agent is configured to output text in response to input text;
defining an agent behavior specification for the agent;
inputting a text input to the agent and monitoring the text output of the agent to detect an incorrect state transition, wherein the incorrect state transition comprises a state transition that deviates from the agent behavior specification;
applying a correction to the output text to create a corrected output text upon detecting the incorrect state transition;
reverting the agent to a previous state, the previous state preceding the state corresponding to the incorrect state transition detected; and
inputting the corrected output text to the agent in the previous state to cause future behavior of the agent to align with the agent behavior specification.

16. The computer system of claim 15, wherein applying a correction to the output text string comprises identifying a longest common string and appending the longest common string to the output text of the previous state.

17. The computer system of claim 15, further comprising training a deep learning algorithm on labeled data to identify an agent state transition, wherein labels of the labeled data define agent states based on associated characteristics.

18. The computer system of claim 15, further comprising uncovering a previously unidentified state, wherein the uncovering a previously undefined state comprises identifying a collection of characteristics that do not correspond to previously defined state.

19. The computer system of claim 15, wherein monitoring the text output of the agent to detect an incorrect state transition comprises:
identifying a collection of characteristics within the output text that correspond to a particular state; and
determining that the particular state is out of sequence with respect to the agent behavior specification.

20. The computer system of claim 15, wherein the agent behavior specification comprises at least one of a correct sequence of state transitions and an incorrect sequence of state transitions.
